(19) United States
(12) Patent Application Publication
(10) Pub. No.: US 2004/0096185 A1
(43) Pub. Date: May 20, 2004

(54) Video signal recording/playback apparatus

(76) Inventors: Seiichi Takeuchi, Osaka (JP); Katsuyuki Nishimura, Osaka (JP); Masaki Sato, Osaka (JP)

Correspondence Address: RATNERPRESTIA, P O BOX 980, VALLEY FORGE, PA, 19482-0980, US

(21) Appl. No.: 10/464,220

(22) Filed: Jun. 18, 2003

(30) Foreign Application Priority Data
Nov. 19, 2002 (JP) 2002-334826

(51) Int. Cl. H04N 5/781

(52) U.S. Cl. 386/46; 386/125

(57) ABSTRACT

A video signal recording/playback apparatus includes a switch and a capture unit. The switch selects and outputs one of a first video signal recorded and played back in a recording medium and a distributed second video signal. The capture unit temporarily storing the video signal output from the switch. Simultaneously to a pause operation requested or after a predetermined period of time from the pause operation, the capture unit stores one image of the video signal and outputs the image as a pause image, and does not store a remaining of the video signal. Then, soon after the switch starts to output the first video signal recording/playbackced by a player, the capture unit starts storing the first video signal and outputs the first video signal as its is. The video signal recording/playback apparatus can smoothly shift from the pause image to an image of the recording/playbackced video signal when shifting from a time keep mode to a playback mode.

### FIELD OF THE INVENTION

The present invention relates to a video signal recording/playback apparatus for recording and playing back video signals in a recording medium.

### BACKGROUND OF THE INVENTION

FIG. 4 is a block diagram of a conventional video signal recording/playback apparatus. A distributor 1 distributes an input video signal 10 into a first video signal 11 and a second video signal 12. A recorder 2 records the first video signal 11 in a recording medium 3. A player 3 plays back the first video signal 11 from the data stored in the recording medium 3. A switch 5 selects one of the first video signal 11 from the player 54 and the second video signal 12 from the distributor 1 and outputs the selected video signal. The output video signal is then converted into an image to be displayed on a display.

In the conventional video signal recording/playback apparatus, the recorder 2 does not record the video signal 11 in the recording medium 3 while the switch 5 selects the second video signal 12 from the distributor 1.

When a pause operation for the second video signal 12 is required by a user, the recorder 2 starts recording the first video signal 11 in the recording medium 3. Soon after the recorder 2 starts recording the first video signal 11, the player 54 starts playing back the first video signal 11 and plays back the beginning image of the first video signal 11. Upon receiving a playback request from the user, the player 54 starts playing back the first video signal 11. The first video signal 11 from the player 54 is then output through the switch 5. The function to record the video signal during a duration of time from the pause operation to the playback operation requested by the user is called “a time keep function”, and the status during the duration is called “a time keep mode”.

A conventional video signal recording/playback apparatuses disclosed in Japanese Patent Laid-Open Publication No.2002-158964 has a simultaneous record/playback function for recording a video signal in a recording medium, such as a hard disk, and retrieving the recorded signal just after the start of the recording. The function also includes a pause function.

The conventional video signal recording/playback apparatus cannot make an image pause during a period of time from the start of the recording of the video signal in the recording medium to the playback of the video signal. Further, the continuity of the display may be interrupted by a display of the pause operation or a transit from the time keep mode to the playing back of the signal.

### SUMMARY OF THE INVENTION

A video signal recording/playback apparatus includes a distributor for distributing a video signal input into first and second video signals, a recorder for recording the first video signal in a recording medium, a player for playing back the recorded first video signal, a switch for selecting one of between the played-back first video signal and the second video signal, and a capture unit for storing the video signal selected by the switch.

The video signal recording/playback apparatus can transit a pause image to a played-back image when the apparatus transits from a time keep mode to a playback mode.

### BRIEF DESCRIPTION OF THE DRAWINGS

FIG. 1 is a block diagram of a video signal recording/playback apparatus according to exemplary embodiment 1 of the present invention.

FIG. 2 is a block diagram of a video signal recording/playback apparatus according to exemplary embodiment 2 of the invention.

FIG. 3 is a block diagram of a video signal recording/playback apparatus according to exemplary embodiment 3 of the invention.

FIG. 4 is a block diagram of a conventional video signal recording/playback apparatus.

### DETAILED DESCRIPTION OF THE PREFERRED EMBODIMENTS

(Embodiment 1)

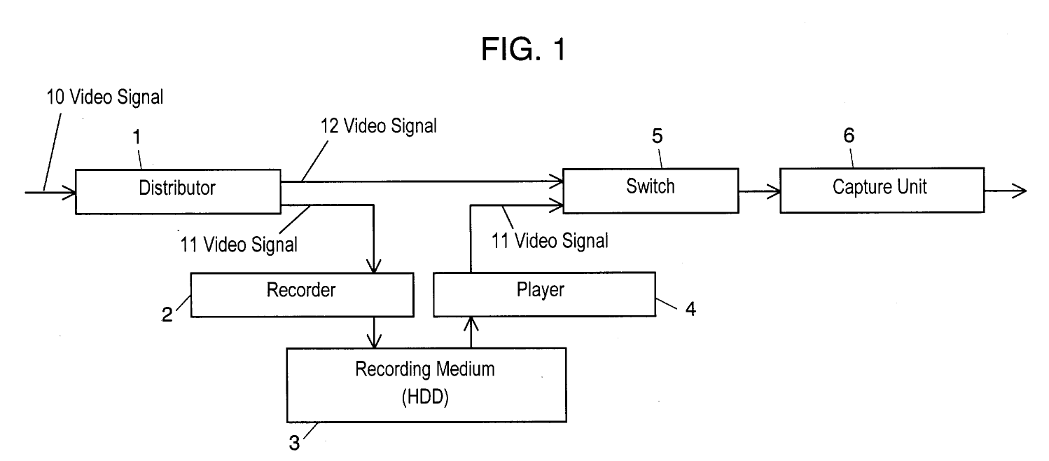

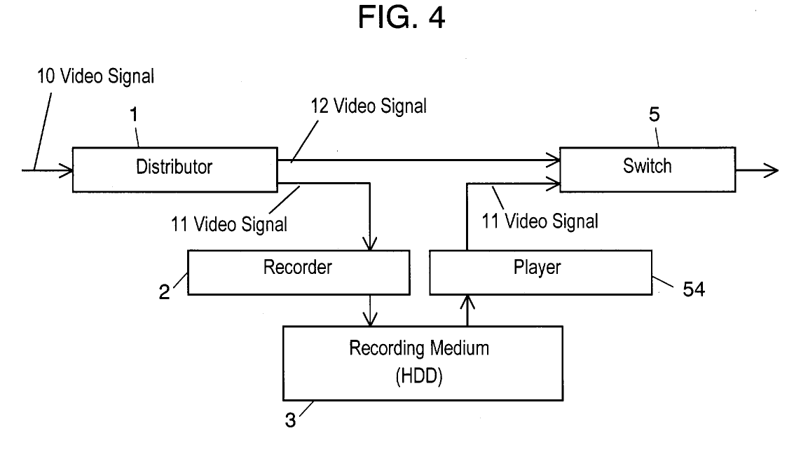

FIG. 1 is a block diagram of a video signal recording/playback apparatus according to exemplary embodiment 1 of the present invention. Like components are denoted by like numerals as those of a conventional video signal recording/playback apparatus shown in FIG. 4 and will be explained in no more detail.

In the video signal recording/playback apparatus of embodiment 1, a recorder 2 does not record a first video signal 11 in a recording medium 3 while a second video signal 12 from a distributor 1 is selected and output by a switch 5.

When a pause operation for having the second video signal 12 pause is required by a user, the recorder 2 starts recording the first video signal 11 in the recording medium 3. When the recorder 2 starts recording the first video signal 11 in the recording medium 3, a player 4 starts playing back the recorded first video signal 11 and continues to play back the beginning image of the first video signal 11. A switch 5 outputs the first video signal 11 soon after the recorded video signal 11 is played back from the player 4.

Simultaneously to the pause operation being requested by the user or after a predetermined period of time (for example, 0.5 second) from the pause operation, a capture unit 6 stores and outputs one image of the second video signal 12 as a pause image and does not store a remaining of the second video signal 12 (a time keep mode). Soon after the player 4 starts playing back the recorded first video image, the switch 5 outputs the played-back first video signal 11, and the capture unit 6 outputs the first video signal input thereto as it is.

The capture unit 6 may continuously outputs the pause image until the start of the playback is requested by the user. When the start of the playback is requested by the user, the capture unit 6 starts outputting the first video signal 11 output through the switch 5.

Until the start of the playback is requested by the user, the switch 5 may continue to output the second video signal 12, and the capture unit 6 may continue to output the pause image. Upon receiving the request for starting the playback, the switch may start outputting the video signal 11 from the player 4, and the capture unit 6 may start outputting the video signal 11 from the switch 5.

By the above operation, simultaneously to the pause operation, the pause image is output, and the video signal is stopped, thus smoothly transiting from the pause image in the time keep mode before the start of playback to the playing-back of the video signal.

(Embodiment 2)

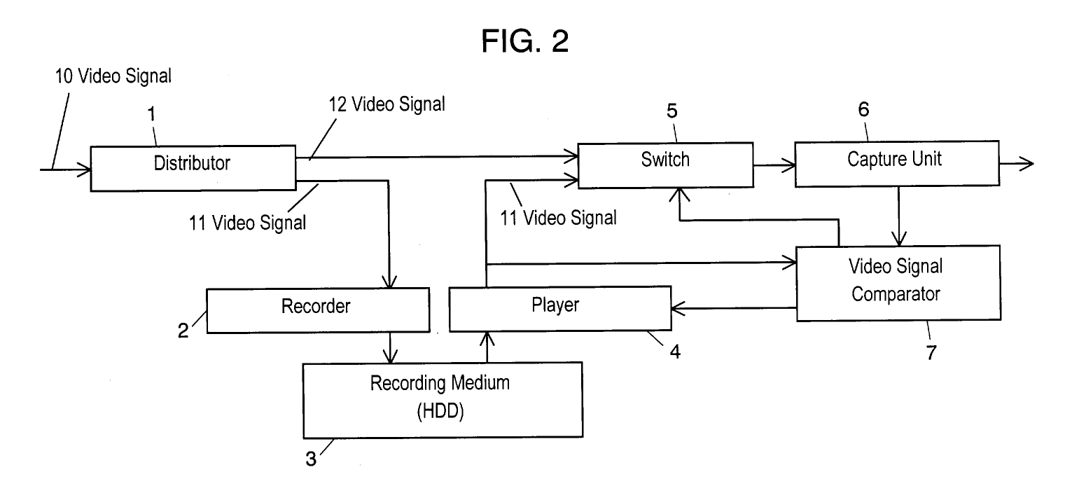

FIG. 2 is a block diagram of a video signal recording/playback apparatus according to exemplary embodiment 2 of the present invention. Like components are denoted by like numerals as those of the video signal recording/playback apparatus of embodiment 1 shown in FIG. 1 and will be explained in no more detail.

In the video signal recording/playback apparatus of embodiment 2, a recorder 2 does not record a first video signal 11 in a recording medium 3 while a switch 5 selects and outputs a second video signal 12 from a distributor 1.

When a pause operation for having the second video signal 12 pause is requested by a user, the recorder 2 starts recording the first video signal 11 in the recording medium 3. When the recorder 2 starts recording the first video signal 11 in the recording medium 3, a player 4 starts playing back the recorded first video signal 11 and continues to output the beginning image of the first video signal 11. A switch 5 outputs the first video signal 11 from the player 4.

Simultaneously to the pause operation requested by the user or after a predetermined period of time (for example, 0.5 second) from the pause operation, a capture unit 6 stores and outputs one image of the second video signal 12 as a pause image and does not store a remaining of the video signal 12. Soon after the switch 5 starts to output the first video signal 11 played back by the player 4, the capture unit 6 starts to output the video signal input thereto.

A video signal comparator 7 compares the image output from the capture unit 6 with an image of the first video signal 11 played back by the player 4 to examine whether or not the images match each other, and send a result of the examination to the player 4. If the result of the examination from the video signal comparator 7 is indicative of not-matching, the player 4 changes the played-back image. The image is then compared with the output of the capture unit 6 by the video signal comparator 7. Until the comparator 7 determines that the images match each other, the player 4 repeats changing the reconstructing image.

If the result of the examination from the comparator 7 is indicative of matching, the switch 5 outputs the first video signal 11 played back by the player 4 soon after the player starts playing back the first video signal 11.

The video signal comparator 7 may compare respective luminance signals of the video signals or compare both of respective luminance signals and respective chroma signals.

The video signal comparator 7 may calculate a difference between the video signals to be compared. The comparator may calculate respective variances, respective motion vectors, or respective frequency dispersions of the video signals.

The comparator 7 may compare the video signals based not only on complete equality but also on close similarity within an allowance.

The comparator 7 may compare the video signals within a given slice of time.

The above operation provides continuity from the pause image in a time keep mode to the played-back video signal in a playback mode.

(Embodiment 3)

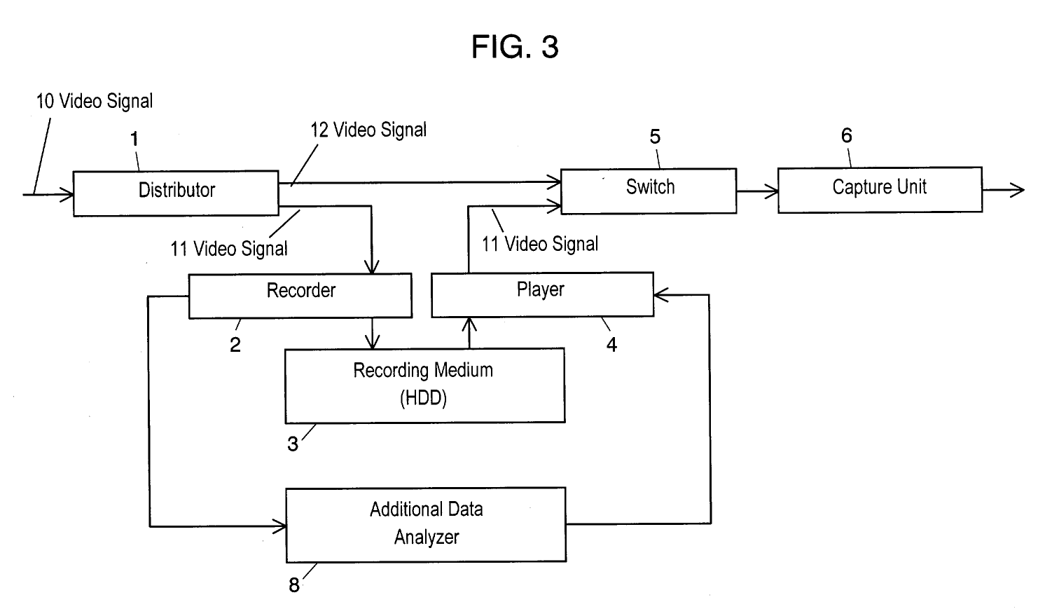

FIG. 3 is a block diagram of a video signal recording/playback apparatus according to exemplary embodiment 3 of the present invention. Like components are denoted by like numerals as those of the video signal recording/playback apparatus of embodiment 1 shown in FIG. 1 and will be explained in no more detail.

In the video signal recording/playback apparatus of embodiment 3, a recorder 2 does not record a first video signal 11 in a recording medium 3 while a switch selects and outputs a second video signal 12 from a distributor 1.

When a pause operation for having the second video signal 12 pause is requested by a user, the recorder 2 starts recording the first video signal 11 in the recording medium 3. The recorder 2 generates additional data for notifying the player 4 of a video signal to be played back. An additional data analyzer 8 analyzes the additional data from the recorder 2 and notifies the player 4 of the video signal to be played back. The additional data contains data indicating a position where the video signal is recorded, such as an ID of a recorded file, a recording date of the video signal to be played back, a position of the video signal in the file (the number of bytes from the beginning of the file). The additional data analyzer 8 analyzes the additional data to extract the position and notifies the player 4 of the position in order for the player 4 to play back the video signal from the recording medium 3. The player 4 plays back an image of the video signal corresponding to the position in the recording medium 4 determined by the additional data analyzer 8 and have the image pause. Soon after the player 4 starts playing back the video signal 11, the switch 5 starts outputting the played-back video signal 11.

Simultaneously to the pause operation requested by the user or after a predetermined period of time (for example, 0.5 second) from the pause operation, a capture unit 6 stores and outputs one image of the video signal 12 as a pause image and does not store a remaining of the video signal 12. Soon after the switch 5 starts outputting the first video signal 11 played back by the player 4, the capture unit starts outputting the input video signal as it is.

The above operation allows transiting from the pause image to an image of the played-back video signal.

According to embodiments 1 to 3, the video signal played back by the player 4 is selected and output by the switch 5 and is output through the capture unit 6 as it is. The video signal may be output from the player 4 at an intermediate time during the playing-back of the video signal, be selected by the switch 5, and output through the capture unit 6 as it is.

The recorder 2 may records the video signal 11 by an analog modulation, an analog-to-digital conversion, an analog band compression, a digital high-efficient encoding, or their combination. The player 4 requires a reverse of the converting operation of the recorder for the video signal 11. The recording medium 3 may be a disk, tape, or a hard disk drive (HDD).

What is claimed is:

1. A video signal recording/playback apparatus comprising:
a distributor for distributing a video signal input thereto into first and second video signals;
a recorder for recording said first video signal in a recording medium;
a player for playing back said recorded first video signal;
a switch for selects and outputs one of said played-back first video signal and said second video signal; and
a capture unit for storing said video signal output from said switch.

2. The video signal recording/playback apparatus according to claim 1, wherein said capture unit outputs an image of said output video signal as a pause image, and said recorder starts recording said first video signal in said recording medium.

3. The video signal recording/playback apparatus according to claim 2, wherein said recorder starts recording said first video signal in said recording medium when said capture unit outputs said image.

4. The video signal recording/playback apparatus according to claim 2, wherein said recorder starts recording said first video signal in said recording medium after a predetermined period of time from said capture unit outputs said image.

5. The video signal recording/playback apparatus according to claim 2, wherein, according to a pause request, said capture unit outputs said image, and said recorder starts recording said first video signal in said recording medium.

6. The video signal recording/playback apparatus according to claim 1, further comprising
a comparator for examining whether or not a video signal output from said capture unit matches said played-back first video signal,
wherein said switch selects and outputs one of said played-back first video signal and said second video signal according to an output from said comparator.

7. The video signal recording/playback apparatus according to claim 1, wherein said recorder generates additional data indicating a position of said first video signal to be played back by said player, said video signal recording/playback apparatus further comprising
an analyzer for analyzing said additional data and directing said player to play back said first video signal at said position.
